(19) United States
(12) Patent Application Publication
(10) Pub. No.: US 2014/0210950 A1
(43) Pub. Date: Jul. 31, 2014

(54) SYSTEMS AND METHODS FOR MULTIVIEW METROLOGY

(71) Applicant: QUALCOMM INCORPORATED, San Diego, CA (US)

(72) Inventors: Kalin Mitkov Atanassov, San Diego, CA (US); Vikas Ramachandra, San Diego, CA (US); James Wilson Nash, San Diego, CA (US); Sergiu Radu Goma, San Diego, CA (US)

(73) Assignee: QUALCOMM INCORPORATED, San Diego, CA (US)

(21) Appl. No.: 13/756,238

(22) Filed: Jan. 31, 2013

(51) Int. Cl. G02B 27/22

(52) U.S. Cl. CPC G02B 27/22
USPC 348/47; 382/154; 382/103

(57) ABSTRACT

Described are systems and methods for measuring objects using stereoscopic imaging. After determining keypoints within a set of stereoscopic images, a user may select a desired object within an imaged scene to be measured. Using depth map information and information about the boundary of the selected object, the desired measurement may be calculated and displayed to the user on a display device. Tracking of the object in three dimensions and continuous updating of the measurement of a selected object may also be performed as the object or the imaging device is moved.

### TECHNICAL FIELD

The present embodiments relate to imaging devices, and in particular, to systems and methods for performing metrology using stereoscopic imaging pairs.

### BACKGROUND

In the past decade, digital imaging capabilities have been integrated into a wide range of devices, including digital cameras and mobile phones. Recently, the ability to capture stereoscopic images with these devices has become technically possible. Device manufacturers have responded by introducing devices integrating multiple digital imaging sensors. A wide range of electronic devices, including mobile wireless communication devices, personal digital assistants (PDAs), personal music systems, digital cameras, digital recording devices, video conferencing systems, and the like, make use of multiple imaging systems to provide a variety of capabilities and features to their users.

Some current handheld electronic devices include more than one image sensor so that they can capture stereoscopic images of particular scenes. In addition to capturing stereoscopic views, some have built devices to perform stereo metrology, which is a method for obtaining spatial measurements to an object using stereoscopic imaging pairs. These systems measure the distance to points of an object For example, some surveying devices include multiple sensors that may be aligned along a horizontal axis when a stereoscopic image is captured. Each image sensor may capture an image of a scene based on not only the position of the digital imaging device but also on the imaging sensors' physical location and orientation on the camera. Since some implementations provide two sensors that may be offset horizontally, the images captured by each sensor may also reflect the difference in horizontal orientation between the two sensors. This difference in horizontal orientation between the two images captured by the sensors provides parallax between the two images.

### SUMMARY

Stereo metrology involves obtaining spatial estimates of an object's length or perimeter using the disparity between boundary points. True 3D scene information is used to extract length measurements of an object's projection onto the 2D image plane. In stereo vision the disparity measurement is highly sensitive to object distance, baseline distance, calibration errors, and relative movement of the left and right demarcation points between successive frames. Therefore a tracking filter is used to reduce position error and improve the accuracy of the length measurement to a useful level. A Cartesian coordinate extended Kalman (EKF) filter can be used based on the canonical equations of stereo vision. A second filter formulated in a modified sensor-disparity (SD) coordinate system may also exhibit lower measurement errors.

One embodiment of the invention is a stereoscopic imaging system having at least two imaging sensors used for measuring the dimensions of an object. In one aspect, an electronic device may act as a “digital ruler” by using the stereo cameras on a cell phone, tablet, or other mobile device to provide real time object measurement. The measurement can be in the X/Y dimension in order to measure the height, length of width of an object in a scene. The measurement can also be in the Z direction, in order to measure distance of the object from the stereoscopic camera.

Other embodiments may include a system for measuring a dimension of an object including a pair of stereoscopic image sensors and a control module. The control module may be configured to capture a stereoscopic image of the object, determine one or more keypoints of the object, determine a boundary of the object from the one or more keypoints, and calculate a dimension of the object based on a length of the determined boundary of the object. The system may also include a display configured to display the object and the calculated dimension.

Another inventive aspect disclosed is a method for measuring a dimension of an object including the steps of capturing a stereoscopic image of the object, determining one or more keypoints of the object, determining a boundary of the object from the one or more keypoints, and calculating a dimension of the object based on a length of the determined boundary of the object.

Other embodiments may include an imaging apparatus, including a pair of stereoscopic image sensors, a sensor control module configured to capture a stereoscopic image of an object, a keypoint module configured to determine one or more keypoints of the object, a boundary calculation module configured to determine a boundary of the object from the one or more keypoints, a user interface module configured to accept a user-selected boundary of the object, a dimension calculation module configured to calculate a dimension of the object based on a length of the determined boundary of the object and a display configured to display the object and the calculated dimension.

Another embodiment may include a non-transitory computer readable medium, storing instructions that when executed by a processor, cause the processor to perform the method of capturing a stereoscopic image of an object, determining one or more keypoints of the object, determining a boundary of the object from the one or more keypoints, calculating a dimension of the object based on a length of the determined boundary of the object, and tracking the one or more keypoints of the object in three dimensions.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows an imaging environment including a stereoscopic imaging device that includes two imaging sensors.

FIG. 2 shows a high-level schematic block diagram illustrating a system for multiview metrology, according to one configuration.

FIG. 3 shows a high-level overview of an image capture and keypoint quality determination process.

FIG. 4 shows a high-level overview of a multiview metrology process.

FIG. 5 shows one example of measuring the dimensions of objects on a planar surface using a multiview metrology process.

FIG. 6 shows one example of measuring the dimensions of objects in a three dimensional scene using a multiview metrology process.

FIG. 7 is a graph showing the convergence of the length error with tracking filters applied according to one embodiment.

FIG. 8 is a graph showing the internal convergence of the error covariance with tracking filters applied according to one embodiment.

### DETAILED DESCRIPTION

Aspects of this invention relate to systems and methods for measuring the dimensions of objects in a scene of interest using a stereoscopic image sensor pair. The stereoscopic image sensor pair may be incorporated into a mobile wireless device, a tablet, a cellular telephone, or other handheld device. One skilled in the art will recognize that the embodiments discussed may be implemented in hardware, software, firmware, or any combination thereof.

Embodiments allow one to use an electronic device having a plurality of image sensors to measure the dimensions of objects captured by the image sensors. For example, one may focus a wireless telephone having stereoscopic image sensors onto a door. The user may tap the image of the door on a touchscreen of the telephone, indicating to the system that dimensions of that object should be measured. The system could then show the vertical and horizontal dimensions of the door on the display screen. In alternate embodiments, the user may use their finger to circle the object to be measured on the touchscreen, or use a stylus to highlight the object. Any way of indicating to the system the chosen object to measure is contemplated by embodiments of the invention.

Aspects of the system may use a programmed process to perform cued feature extraction, triangulation, position measurement, state estimation and real-time display of the calculated dimensions of the measured object on a display screen. In one embodiment, the calculated dimensions are overlaid on a display screen showing the objects being measured in real time. The feature extraction is general enough to permit extraction of multiple types of features from a variety of different captured objects. Some objects may be two dimensional, such as a drawing on a chalkboard. Other objects may be three dimensional, such as a bowling ball or other physical products. In one embodiment, a multiscale refinement procedure may be used which iteratively improves the location of the keypoints responsible for object demarcation. For example, as the user chooses an object to measure, the system will designate keypoints of that object on the screen so the object can be tracked as the image sensors are moved by the user during normal video capture. This allows the user to zoom, or rotate, the imaging device while still maintaining a lock on the object to be measured.

Small errors in pixel values can translate to large errors in depth calculations. Therefore, a tracking filter is used to reduce the errors below the measurement noise floor. A tracking filter with predictive capacity can be used to reduce errors due to hand panning motion, jitter, or to continue tracking when the object intermittently resides outside the field of view. A tracking filter may also provide additional useful information such as velocity measurements which may be useful in applications. The filter may also be combined with onboard sensors such as accelerometers to increase estimation accuracy.

An Extended Kalman Filter (EKF) may be used to resolve any nonlinear relationship between the triangulated distance to the object (z-coordinate) and the disparity found within the images. The Kalman filter may help reduce the error caused by random camera jitter experienced during panning and provides true 3D position, velocity, and the dimension of the user defined object within the captured image frames.

A constrained least squares triangulation procedure can reduce the error caused by inconsistent motion of stereo keypoints relative to motion of the object. The ability of the system to precisely identify extremal points, combined with the tracking function, may overcome limitations of earlier systems in which small changes in the position estimates induce large errors in the measurement. The results of the error analysis allow the system designer to posit an error budget which bounds the maximum error for a given baseline and working object distance.

In one aspect, a stereoscopic image sensor pair captures images from multiple image frames. Capturing multiple images, in some embodiments at least about 10 images, reduces error and achieves greater accuracy of the measurement. The use of multiple frames also allows the system to be more robust to allow for movement of the image sensor pair due to the unsteadiness of the operator, such as jitter. Thus, the system can capture multiple images of a scene and then determine keypoints relating to the object to be measured. Keypoints may be distinctive regions on an image that exhibit particularly unique characteristics. For example, regions that exhibit particular patterns or edges may be defined as keypoints. A keypoint match may include a pair of points, with one point identified in the first image and the second point identified in the second image.

In some embodiments, more than two images of a scene may be captured. Therefore, in some embodiments, a set of keypoint matches may include a set of points, with one point identified in the first image, another point identified the second image, a third point identified in the third image and so on for as many images as are captured of the scene. Keypoint matches may also include pairs or sets of regions, with one region from each image captured of the scene of interest. These points or regions of each image may exhibit a high degree of similarity.

An affine fit between the keypoint matches may be performed. This may approximate roll, pitch, and scale differences between the images of the stereoscopic image pair. A correction based on the affine fit may then be performed on the keypoint matches to correct for the roll, pitch and scale differences. A projective fit may then be performed on the adjusted keypoints to determine any yaw differences that may exist between the images of the stereoscopic image pair. Alternatively, the projective fit may be performed on unadjusted keypoints. Based on the estimated roll, yaw, pitch, and scale values, a projection matrix may be determined. The keypoints may then be adjusted based on the projection matrix.

After determining these keypoints, the system may correlate the keypoints of one image frame with the same keypoints in other image frames to accurately determine the three dimensional position of objects in the scene. From those determined positions and keypoints, an accurate measurement of an object in the scene of interest can be made.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

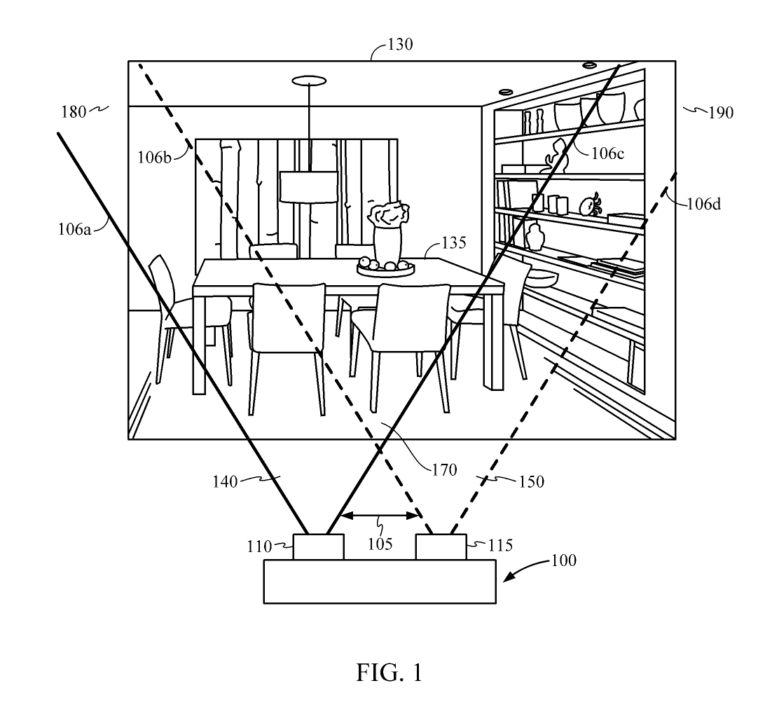

FIG. 1 shows an imaging environment including a stereoscopic imaging device 100 that includes two imaging sensors, 110, and 115. The imaging device 100 is illustrated capturing a scene 130. Each imaging sensor of the imaging device includes a field of view, indicated by the dark lines 160a-d. The left image sensor 110 includes a field of view 140 bounded by lines 160a and 160c. The right image sensor 115 includes a field of view 150, which is bounded by lines 160b and 160d. The fields of view 140 and 150 overlap in area 170. The left image sensor's field of view 140 includes a portion of the scene not within the field of view of image sensor 115. This is denoted as area 180. The right image sensor's field of view 150 includes a portion of the scene not within the field of view of image sensor 110. This is denoted as area 190. These differences in the field of view of the two image sensors 110 and 115 may be exaggerated for purposes of illustration.

The differences in the field of view and the different relative positions of each image sensor 110 and 115 may create parallax between the images. FIG. 1 also shows a horizontal displacement 105 between the two image sensors 110 and 115. This horizontal displacement provides the parallax used in a stereoscopic image to create the perception of depth. While this displacement between the two imaging sensors may be an intentional part of the imaging device's design, other unintended displacements or misalignments between the two imaging sensors 110 and 115 may also be present.

For example, an image of a table 135 may be captured in multiple image frames so that the user may determine the exact height of the table 135, as shown in FIG. 1. The user may select the top and bottom of the table using a touchscreen, or using a mouse selection before, during, or after image frames have been captured. The system then assigns keypoints relating to the table so that the same points on the table can be correlated to the captured pixels in the image frames. By then calculating the depth and three dimensional position of the table using the stereoscopic camera, the exact height of the table 135 can be determined.

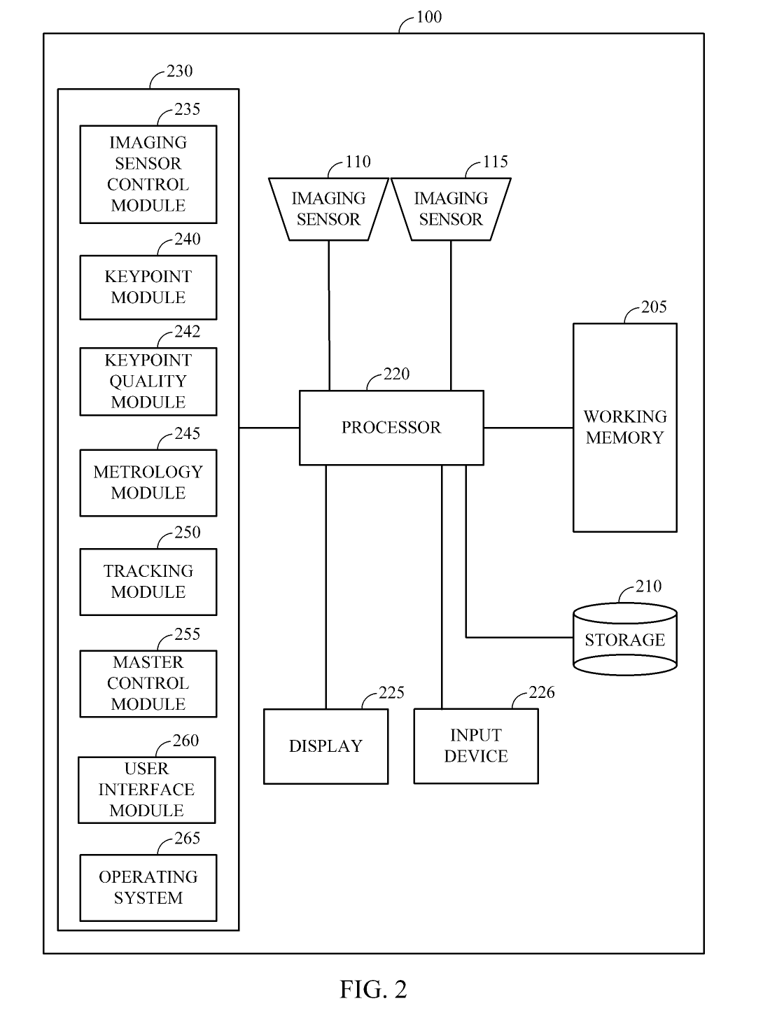

FIG. 2 is a high-level block diagram of the imaging device 100 implementing at least one operative embodiment. The imaging device 100 includes a processor 220 operatively coupled to several components, including a memory 230, a first image sensor 110, a second image sensor 115, a working memory 205, a storage 210, a display 225, and an input device 226.

Imaging device 100 may receive input via the input device 226. For example, input device 226 may be comprised of one or more input keys included in imaging device 100. These keys may control a user interface displayed on the electronic display 225. Alternatively, these keys may have dedicated functions that are not related to a user interface. For example, the input device 226 may include a shutter release key. The input device 226 may also comprise a touch-sensitive screen on which a user may input a desired measurement by touching a boundary of an object. The imaging device 100 may store images captured into the storage 210. These images may include stereoscopic images captured by the imaging sensors 110 and 115. The working memory 205 may be used by the processor 220 to store dynamic run time data created during normal operation of the imaging device 100.

The memory 230 may be configured to store several software or firmware code modules. These modules contain instructions that configure the processor 220 to perform certain functions as described below. For example, an operating system module 265 includes instructions that configure the processor 220 to manage the hardware and software resources of the device 100. An imaging sensor control module 235 includes instructions that configure the processor 220 to control the imaging sensors 110 and 115. For example, some instructions in the imaging sensor control module 235 may configure the processor 220 to capture an image with imaging sensor 110 or imaging sensor 115. Therefore, instructions in the imaging sensor control module 235, along with imaging sensors 110 and 115 may represent one means for capturing a stereoscopic image. Other instructions in the imaging sensor control module 235 may control settings of the image sensor 110. For example, the shutter speed, aperture, or image sensor sensitivity may be set by instructions in the imaging sensor control module 235.

A keypoint module 240 includes instructions that configure the processor 220 to identify keypoints within images captured by imaging sensors 110 and 115. As mentioned earlier, in one embodiment, keypoints are distinctive regions on an image that exhibit particularly unique characteristics. For example, regions in the image that exhibit particular patterns or edges may be identified as keypoints. Keypoint module 240 may first analyze a first image captured by the imaging sensor 110 of a target scene and identify keypoints of the scene within the first image. The keypoint module 240 may then analyze a second image captured by imaging sensor 115 of the same target scene and identify keypoints of the scene within that second image. Keypoint module 240 may then compare the keypoints found in the first image and the keypoints found in the second image in order to identify keypoint matches between the first image and the second image. A keypoint match may include a pair of points, with one point identified in the first image and the second point identified in the second image. The points may be a single pixel or a group of 2, 4, 8, 16 or more neighboring pixels in the image. Keypoint matches may also include pairs of regions, with one region from the first image and one region from the second image. These points or regions of each image may exhibit a high degree of similarity. The set of keypoint matches identified for a stereoscopic image pair may be referred to as a keypoint constellation. Therefore, instructions in the keypoint module may represent one means for determining one or more keypoints of the object and for determining a set of keypoint matches in common in a first image and second image of each stereoscopic image.

A keypoint quality module 242 may include instructions that configure processor 220 to evaluate the quality of a keypoint constellation determined by the keypoint module 240. For example, instructions in the keypoint quality module 242 may evaluate the numerosity or relative position of keypoint matches in the keypoint constellation. The quality of the keypoint constellation may be comprised of multiple scores, or it may be a weighted sum or weighted average of several scores. For example, the keypoint constellation may be scored based on the number of keypoint matches within a first threshold distance from the edge of the images. Similarly, the keypoint constellation may also receive a score based on the number of keypoint matches. The keypoint constellation may also be evaluated based on the proximity of each keypoint to a corner of the image. As described earlier, each keypoint may be assigned one or more corner proximity scores. The scores may be inversely proportional to the keypoint's distance from a corner of the image. The corner proximity scores for each corner may then be added to determine one or more corner proximity scores for the keypoint constellation. These proximity scores may be compared to a keypoint corner proximity quality threshold when determining whether the keypoint constellation's quality is above a quality threshold.

The sensitivity of the projective fit derived from the keypoints may also be evaluated to at least partially determine an overall keypoint constellation quality score. For example, a first affine fit and a first projective fit may be obtained using the keypoint constellation. This may produce a first set of angle estimates for the keypoint constellation based on pitch, roll, or yaw errors between two images of a stereoscopic image pair. Next, random noise may be added to the keypoint locations. After the keypoint locations have been altered by the addition of the random noise, a second affine fit and a second projective fit may then be performed based on the noisy keypoint constellation, resulting in a second set of angle estimates of the pitch, roll, or yaw errors between two images of a stereoscopic image pair.

Next, a set of test points may be determined. The test points may be adjusted based on the first set of angle estimates and also adjusted based on the second set of angle estimates. The differences in the positions of each test point between the first and second set of angle estimates may then be determined. An absolute value of the differences in the test point locations may then be compared to a projective fit sensitivity threshold. If the differences in test point locations are above the projective fit sensitivity threshold, the keypoint constellation quality level may be insufficient to be used in performing adjustments to the keypoint constellation and the stereoscopic image pair. If the sensitivity is below the threshold, this may indicate that the keypoint constellation is of a sufficient quality to be used as a basis for adjustments to the stereoscopic image pair.

The scores described above may be combined to determine a keypoint quality level. For example, a weighted sum or weighted average of the scores described above may be performed. This combined keypoint quality level may then be compared to a keypoint quality threshold. If the keypoint quality level is above the threshold, the keypoint constellation may be used to determine misalignments between the individual images that make up the stereoscopic image.

The keypoint quality module may further perform a vertical disparity determination. The keypoint quality module 242 may include instructions that configure processor 220 to determine vertical disparity vectors between a stereoscopic image pair's matching keypoints in a keypoint constellation. The keypoint constellation may have been determined by the keypoint module 240. The size of the vertical disparity vectors may represent the degree of any misalignment between the imaging sensors utilized to capture the images of the stereoscopic image pair. Therefore, instructions in the vertical disparity determination module may represent one means for determining the vertical disparity between keypoint matches.

The keypoint quality module 242 may include instructions that configure the processor 320 to perform an affine fit on a stereoscopic image pair's keypoint match constellation. The keypoint quality module 242 may receive as input the keypoint locations in each of the images of the stereoscopic image pair. By performing an affine fit on the keypoint constellation, the module may generate an estimation of the vertical disparity between the two images. The vertical disparity estimate may be used to approximate an error in pitch between the two images. The affine fit may also be used to estimate misalignments in roll, pitch, and scale between the keypoints in a first image of a stereoscopic image pair and the keypoints of a second image of the stereoscopic image pair.

The keypoint quality module 242 may further include instructions that configure the processor 220 to adjust keypoint locations based on the affine fit. By adjusting the location of keypoints within an image, the module may correct misalignments in roll, pitch, or scale between the two set of keypoints from a stereoscopic image pair.

The keypoint quality module 242 may include instructions that configure the processor 220 to generate a projection matrix based on the keypoint constellation of a stereoscopic image pair. The projective fit may also produce a yaw angle adjustment estimate. The projection matrix may be used to adjust the locations of a set of keypoints in one image of a stereoscopic image pair based on locations of a second set of keypoints in another image of the stereoscopic image pair. To generate the projection matrix, the keypoint quality module 242 receives as input the keypoint constellation of the stereoscopic image pair. The keypoint quality module 242 may further include instructions that configure the processor 220 to perform a projective correction on a keypoint constellation or on one or both images of a stereoscopic image pair based on the projection matrix.

The metrology module 245 may include instructions that configure the processor 220 to measure a selected dimension of an object. The measurements may be based on a calculated depth map of the stereoscopic image based on the parallax between the two images. The disparity is measured based on the estimated keypoint locations in the right and left images. Robust triangulation is used to improve the disparity estimate.

The tracking module 250 includes instructions that configure the processor 220 to track a selected dimension of an object as the imaging sensors or the object moves. The disparity and keypoint position measurements are used as input to the object tracker. Periphery keypoints of the object are used to measure object dimensions. The nonlinear differential equations of motion and triangulation of the selected keypoints are linearized for use in a tracking filter. The tracking filter uses outlier rejection to remove keypoints outside of the validation region. The statistics of the feature extraction are used to model the noise covariance. The tracking filter operates adaptively to decrease the estimation error below the nominal noise levels.

The tracking filter equations may be developed as follows.

Let (X, Y, Z), (X′, Y′, Z′), (x, y), (x′, y′), (i, j), and (i′, j′) represent points in the Cartesian coordinate systems of the reference camera, auxiliary camera, reference sensor plane, auxiliary sensor plane, reference image, and auxiliary image, respectively. The basic equations of a canonical stereo system are

$$\begin{matrix}X = \frac{x}{d} \\ Y = \frac{y}{d} & ( 1 ) \\ Z = \frac{1}{d} & ( 2 )\end{matrix}$$

where the normalized disparity is d=D/B, wherein D is the disparity, B is baseline separation distance, and Z is the object distance normalized by the focal length f. The sensor frame disparity is related to the pixel disparity by

D=x′−x=w(j′−j) (3)

where w is the sensor pitch. The linear constant velocity state equation describing the object kinematics is

r(t)=Fr(t−1)+q(t) (4)

where

$$\begin{matrix}r ( t ) = {[ \begin{matrix}X ( t ) & Y ( t ) & Z ( t ) & \dot{X} ( t ) & \dot{Y} ( t ) & \dot{Z} ( t )\end{matrix} ]}^{*} & ( 5 ) \\ F = [ \begin{matrix}1 & 0 & 0 & T & 0 & 0 \\ 0 & 1 & 0 & 0 & T & 0 \\ 0 & 0 & 1 & 0 & 0 & T \\ 0 & 0 & 0 & 1 & 0 & 0 \\ 0 & 0 & 0 & 0 & 1 & 0 \\ 0 & 0 & 0 & 0 & 0 & 1\end{matrix} ] & ( 6 )\end{matrix}$$

q(t) represents a white noise acceleration model with maximum acceleration q , and T is the exposure time.

The measurements are the pixel values of the object's keypoint and the disparity between the corresponding points in both image sensors. These are related to the states by the measurement equation

$$m ( t ) = {h}_{r} [ r ( t ) ] + v ( t ) \\ \begin{matrix}[ \begin{matrix}x \\ y \\ d\end{matrix} ] = [ \begin{matrix}{h}_{1} ( r ) \\ {h}_{2} ( r ) \\ {h}_{3} ( r )\end{matrix} ] \\ = [ \begin{matrix}X / Z \\ Y / Z \\ 1 / Z\end{matrix} ] + v ( t )\end{matrix} \qquad ( 7 )$$

The zero mean measurement noise v(t) has non-diagonal covariance matrix R due to the correlation between disparity and the x position in the sensor plane through (3).

Thus the state propagation is linear and the measurement is nonlinear in this formulation. A straightforward application of the Extended Kalman filter (EKF) may now be used to track the 3D position. The EKF equations are mentioned briefly below.

\hat{r}(t|t−1)=F\hat{r}(t−1), state prediction (9)

P(t|t−1)=FP(t)F*+Q, predicted error covariance (10)

K(t)=P(t|t−1)Ĥ*(t)[\dot{H}(t)P(t|t−1)Ĥ*(t)+(t)+R]⁻¹, optimum gain (11)

\hat{r}(t)=\hat{r}(t|t−1)+K(t)[m(t)−h(\hat{r}(t|t−1)], state correction (12)

P(t)=(I−K(t)Ĥ(t))P(t|t−1), error covariance update (13)

where the Jacobian matrix H(r) with entries Hᵢⱼ=ôhᵢ/ôrⱼ is

$$H ( r ) = [ \begin{matrix}1 / Z & 0 & - X / {Z}^{2} & 0 & 0 & 0 \\ 0 & 1 / Z & - Y / {Z}^{2} & 0 & 0 & 0 \\ 0 & 0 & - 1 / {Z}^{2} & 0 & 0 & 0\end{matrix} ] \qquad ( 8 )$$

and Ĥ(t)=H(\hat{r}(t|t−1)). Initialization is to the first measurement and zero velocities

\hat{r}(l)=[h⁻¹(m(l))0 0 0] (14)

If another coordinate system can be found such that an invertible transformation exists, the filter equations may be reformulated in terms of the new coordinate system. By formulating the filter equations in the new coordinate system, advantages in stability and asymptotic range estimation often result because the noise covariance matrices are better posed.

In the following a transformation by algebraic methods was developed which avoids the solution to a complicated system of nonlinear coupled differential equations.

Letting s(t) denote the new coordinate system invertible transformations may be found:

r=fᵣ(s) (17)

s=fₛ(r) (18)

Then transform (4) from Cartesian to sensor-disparity (SD) coordinates by substituting (17) for r(t−1) and then applying (18) to both sides which results in

s(t)=f(s(t−1)) (19)

where

f(s)□fₛ[Ffᵣ(s)+q(t)] (20)

This technique has many similarities with the well-known method for preserving unbiasedness in any coordinate system by converting measurements. Define the sensor-disparity (SD) coordinates

$$s = {\frac{1}{d} [ \begin{matrix}\dot{x} & x & \dot{d} & 1 & \dot{y} & y\end{matrix} ]}^{*} \qquad ( 21 )$$

In this coordinate system the differential equations of constant velocity motion are

\dot{s}−[−s₁s₃ s₁−s₂s₃ −s₃² −s₄s₃ −s₅s₃ s₅−s₆s₃]* (22)

Differentiating (21), (5) and substituting into (5), (21), respectively, yields

$$\begin{matrix}\begin{matrix}s = {f}_{s} ( r ) \\ = {[ \begin{matrix}{r}_{4} - \frac{{r}_{6}}{{r}_{3}} {r}_{1} & {r}_{1} & - \frac{{r}_{6}}{{r}_{3}} & {r}_{3} & {r}_{5} - \frac{{r}_{6}}{{r}_{3}} {r}_{2} & {r}_{2}\end{matrix} ]}^{*}\end{matrix} & ( 23 ) \\ \begin{matrix}r = {f}_{r} ( s ) \\ = {[ \begin{matrix}{s}_{2} & {s}_{6} & {s}_{4} & {s}_{1} - {s}_{2} {s}_{3} & {s}_{5} - {s}_{6} {s}_{3} & - {s}_{3} {s}_{4}\end{matrix} ]}^{*}\end{matrix} & ( 24 )\end{matrix}$$

Applying (24) to the right hand side of (4) gives

$$r ( t ) = [ \begin{matrix}{s}_{2} ( 1 - {Ts}_{3} ) + {Ts}_{1} \\ {s}_{6} ( 1 - {Ts}_{3} ) + {Ts}_{5} \\ {s}_{4} ( 1 - {Ts}_{3} ) \\ {s}_{1} - {s}_{2} {s}_{3} \\ {s}_{5} - {s}_{6} {s}_{3} \\ - {s}_{3} {s}_{4}\end{matrix} ] ( t - 1 ) + q ( t ) \qquad ( 25 )$$

and substituting the result into (23) results in the SD state equation (26):

$$\begin{matrix}s ( t ) = f [ s ( t - 1 ) ] \\ = [ \begin{matrix}\frac{{s}_{1}}{1 - {Ts}_{3}} & {s}_{2} ( 1 - {Ts}_{3} ) + {Ts}_{1} & \frac{{s}_{3}}{1 - {Ts}_{3}} & {s}_{4} ( 1 - {Ts}_{3} ) & \frac{{s}_{5}}{1 - {Ts}_{3}} & {s}_{6} ( 1 - {Ts}_{3} ) + {Ts}_{5}\end{matrix} ] {( t - 1 )}^{*}\end{matrix}$$

The measurement equation is

$$\begin{matrix}z ( t ) = [ \begin{matrix}x / d \\ y / d \\ 1 / d\end{matrix} ] \\ = Hs ( t ) + {v}_{s} ( t )\end{matrix} \\ with \\ H = [ \begin{matrix}0 & 1 & 0 & 0 & 0 & 0 \\ 0 & 0 & 0 & 0 & 0 & 1 \\ 0 & 0 & 0 & 1 & 0 & 0\end{matrix} ] \qquad ( 27 )$$

and vₛ(t) represents the measurement noise associated with the disparity normalized measurements. Since the measurement vector elements correspond to the X, Y, and Z positions of the model, if the object motion is independent in all three directions, the measurement noise becomes decoupled.

EKF may be applied to (26) and (27) this time with the nonlinearity residing in the state equation. The equations are:

ŝ(t|t−1)=f(ŝ(t|t−1)), state prediction (28)

P(t|t−1)=\hat{F}(t)P(t)\hat{F}(t)*, error covariance prediction (29)

K(t)=P(t|t−1)H [HP(t|t−1)H+Rₛ]⁻¹, optimum gain (30)

ŝ(t)=ŝ(t|t−1)+Kₛ(t)[z(t)[z(t)−Hₛŝ(t|t−1)], state correction (31)

P(t)=(I−K(t)H)P(t|t−1), error covariance update (32)

where

$$F ( s ) = [ \begin{matrix}1 / ( 1 - {Ts}_{3} ) & & {Ts}_{1} / {( 1 - {Ts}_{3} )}^{2} & & & \\ T & 1 - {Ts}_{3} & - {Ts}_{2} & & & \\ & & 1 / {( 1 - {Ts}_{3} )}^{2} & & & \\ & & - {Ts}_{4} & 1 - {Ts}_{3} & & \\ & & {Ts}_{5} / {( 1 - {Ts}_{3} )}^{2} & & 1 / ( 1 - {Ts}_{3} ) & \\ & & - {Ts}_{6} & & T & 1 - {Ts}_{3}\end{matrix} ] \qquad ( 33 )$$

with has elements Fᵢⱼ=ôfᵢ/ôsⱼ and \hat{F}(t)=F(ŝ(t|t−1)). Initialization uses the first measurement and zero velocities

ŝ(l)=z(l) (34)

In this coordinate system the length of an object can more naturally be accommodated. If the length is placed as a state in the Cartesian filter a nonlinear state equation will result which destroys the advantage of simplicity. If the length is linear in the state, then the measurement is synthetic which causes correlations in the noise covariance. It is preferred to have the smallest number of uncorrelated measurements thus maximizing the information content and minimizing the dimensionality of the problem. In the SD system if we let s₇=l(t)={square root over (X(t)²+Y(t)²+Z)t)²)} and s₈=\dot{l}(t) then

$$\begin{matrix}{s}_{7} = \sqrt{{s}_{2}^{2} + {s}_{6}^{2} + {s}_{4}^{2}} & ( 15 ) \\ {s}_{8} = \frac{1}{\sqrt{{s}_{7}}} [ {s}_{2} ( {s}_{1} - {s}_{2} {s}_{3} ) + {s}_{6} ( {s}_{5} - {s}_{6} {s}_{3} ) - {s}_{4}^{2} {s}_{3} ] & ( 16 )\end{matrix}$$

and an object's radial distance can be easily added to the state model.

A master control module 255 includes instructions to control the overall functions of imaging device 100. For example, master control module 255 may invoke subroutines in imaging sensor control module 235 to capture a stereoscopic image pair by first capturing a first image using imaging sensor 110 and then capturing a second image using imaging sensor 115. Master control module 255 may then invoke subroutines in the keypoint module 240 to identify keypoint matches within the images of the stereoscopic image pair. The keypoint module 240 may produce a keypoint constellation that includes keypoints matches between the first image and the second image. The master control module 255 may then invoke subroutines in the keypoint quality module 242 to evaluate the quality of the keypoint constellation identified by the keypoint module 240. If the quality of the keypoint constellation is above a threshold, master control module may then invoke additional subroutines in the keypoint quality module 242 to determine vertical disparity vectors between matching keypoints in the keypoint constellation determined by keypoint module 240. If the amount of vertical disparity indicates a need for adjustment of the stereoscopic image pair, the master control module 255 may invoke additional subroutines in the keypoint quality module 242 in order to adjust the keypoint constellation.

The master control module 255 may also store calibration data such as a projection matrix in a stable non-volatile storage such as storage 210.

### Image Acquisition and Keypoint Quality Determination Overview

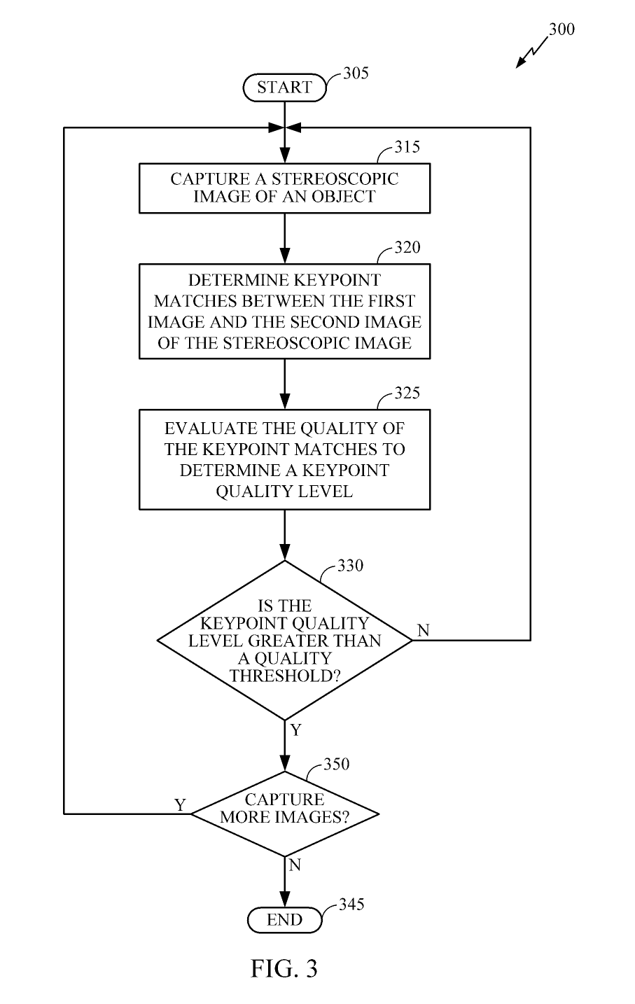

A high-level flow chart of a process 300 for capturing sets of images using a stereoscopic imaging sensor pair and determining the quality of the keypoint matches is shown in FIG. 3. The quality of the keypoint matches is important for making accurate measurements of objects within an imaged scene. Keypoint match quality is also important for tracking the object and the measurement in three dimensions, and for accurately displaying the object and the measurement on a display device.

The process 300 may be implemented in the memory 230 of device 100, illustrated in FIG. 2. Process 300 begins at start block 305 and transitions to block 315 wherein a stereoscopic image of an object is captured. The process 300 then transitions to block 320, wherein the keypoint matches between the first image and the second image of the stereoscopic image are determined.

Process 300 next transitions to block 325, wherein the quality of the keypoint matches is evaluated to determine a keypoint quality level. After the keypoint quality level is determined, process 300 transitions to block 330 where the keypoint quality level is compared to a quality threshold. If the determined keypoint quality level is greater than the quality threshold, process 300 transitions to block 350 where a decision is made regarding capturing additional images. If additional stereoscopic images are desired, process 300 transitions to the start and the process 300 is repeated as outlined above. However, if additional images are not desired, the process 300 transitions to block 345 and ends.

If the determined keypoint quality level is less than a quality threshold, process 300 transitions from block 330 back to the start, and the process 300 repeats as above with the acquisition of a stereoscopic image of an object as stated in block 315.

### Multiview Metrology Process Overview

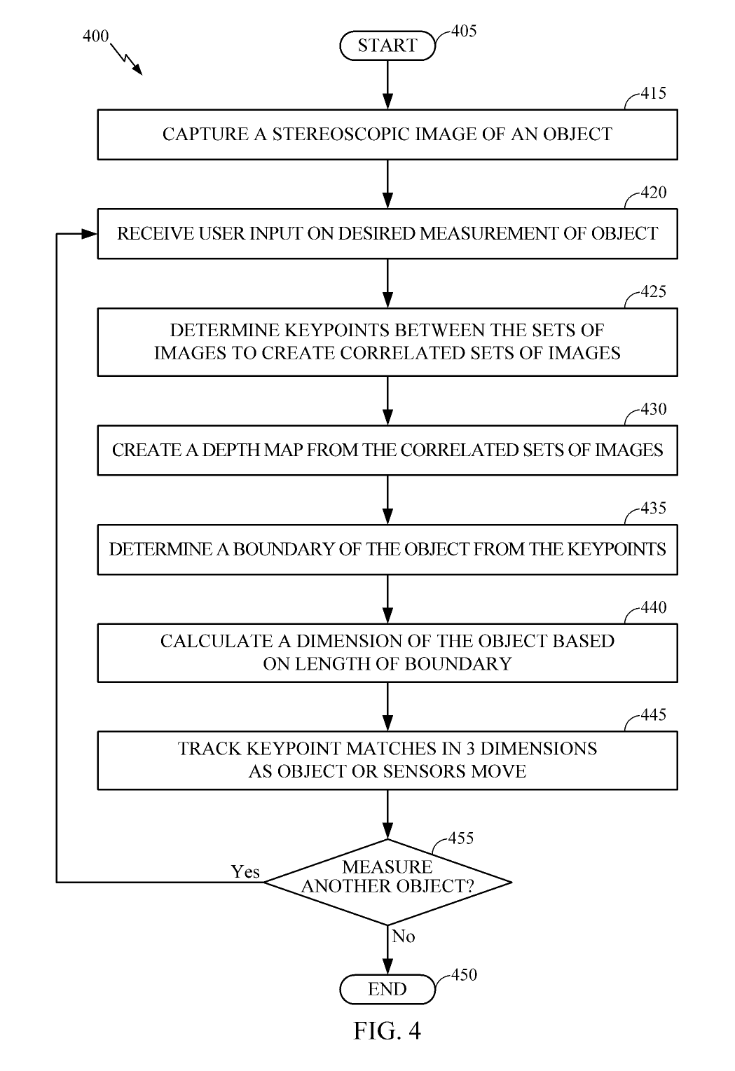

A process for performing metrology of an object using multiple image sensors is outlined in the flow chart of FIG. 4. The process 400 begins at start block 405 and transitions to block 415 wherein a stereoscopic image of an object in a scene is captured. Process 400 then transitions to block 420 wherein user input is received on a desired measurement of an object in the imaged scene. For example, this user input may come in the form of a mouse selection or by touching the periphery of the object to be measured on a touch-sensitive device displaying the object. Once a user has indicated the desired measurement, process 400 then transitions to block 425 wherein keypoints of the object are determined to create correlated sets of images. Additional keypoints may be created and refined automatically by feature extraction performed on the user-selected object. These keypoints are then used as inputs to the tracker and metrology functions.

After determining keypoints, process 400 transitions to block 430, wherein a depth map is created from the correlated sets of images. Process 400 transitions to block 435 wherein a boundary of the object is determined from the keypoints and feature extraction. The process 400 then transitions to block 440 wherein a dimension of the object is calculated based on a length of the boundary using the depth map information previously determined.

Tracking of the keypoint matches in 3 dimensions is next performed in block 445. The determined measurement may be tracked as the imaging sensors move, either due to intentional panning of the electronic device or to unintentional movement such as operator unsteadiness. The keypoint matches may also be tracked as the object moves away from a still camera. This allows an object's dimensions to be continuously tracked by the electronic device, and may also, in some embodiments, allow for other measurements such as velocity or volume of an object.

Once the keypoint matches are tracked, a decision is made in block 455 as to whether the user desires another measurement of an object within the imaged scene. If another measurement is desired, process 400 transitions to block 420 in which user input as to the desired measurement is received, as described above, and the process continues as previously described. If the user does not desire another measurement, the process 400 transitions to block 450 and ends.

### Metrology Examples

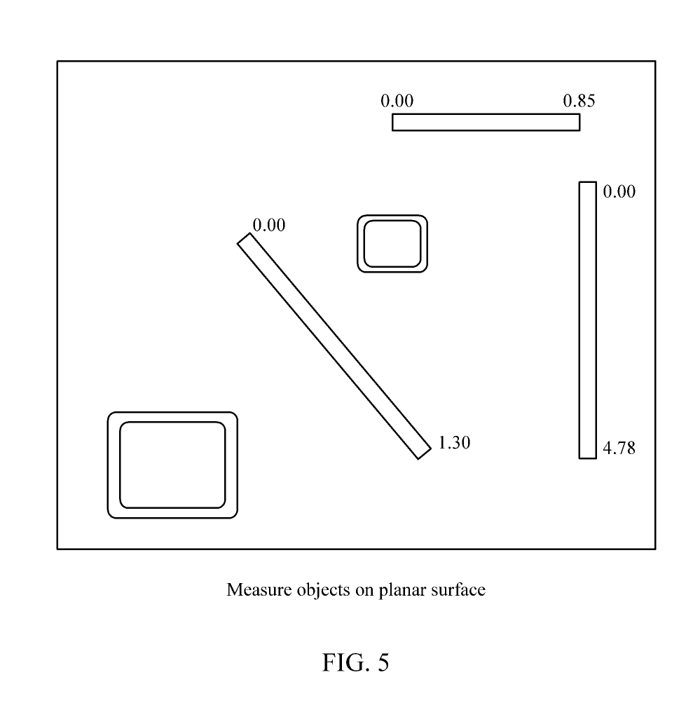

One example of the measurement of the dimensions of various objects performed using multiview metrology may be seen in FIG. 5. In this figure, a set of measurements are taken of various objects on a planar surface. The objects may be oriented vertically, as with object 505, or they may be oriented horizontally, as with object 510. The multiview metrology process as defined above may also measure objects oriented neither horizontally nor vertically, as with object 515. The measurements of the objects may be superimposed on the image of the object displayed on the display of an electronic device. This display may either be located within the same electronic device as the imaging sensors or it may be a separate display. The measurements may be tracked and continuously updated as the imaging sensors on the imaging device move, either due to camera jitter or through intentional movement such as panning The measurement is displayed in real-time to the user. Also displayed in real time is the accuracy of the measurement, such as +/- 1 cm. The measurement may be displayed after a certain accuracy is reached. The accuracy will depend on many variables such as the object distance, camera separation, pixel size, and camera calibration quality.

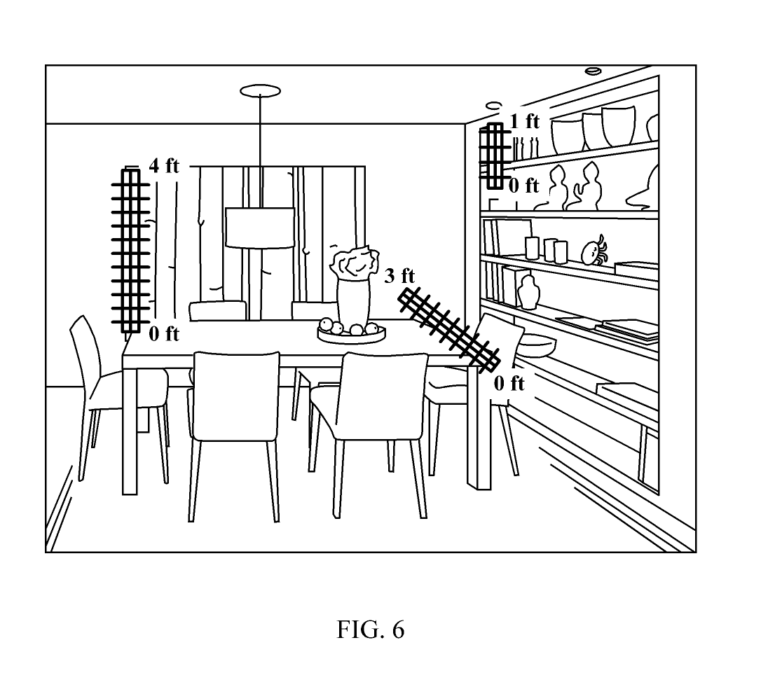

A second example of multiview metrology using stereoscopic imaging is shown in FIG. 6. In this example, dimensions of various objects are displayed on an imaged scene. The user may select a desired measurement, such as the width of the table. By tapping the periphery of the table, the user indicates the desired object to be measured. Using the boundary information and the calculated depth map from the stereoscopic images, the width of the table may be determined. Other measurements, such as the height of various objects at different depths within the three-dimensional scene, may also be calculated.

### Experimental Results

A Monte-Carlo simulation was performed for 100 trial measurements of a moving object whose x and z velocities reverse from 1 mm/frame at intervals of 25 and 50 frames. The same measurement data was input to both of the tracking filters discussed above over 100 frames of x, y, and d measurements with errors of 4.5 and 30 pixels, respectively. The baseline was 10 cm, the frames were 5 MP, and the sensor was 1/2.5 format. There are two sources of related errors. One source of error is in the location of the keypoint in both sensor frames and the other source of error is in the disparity which results from those errors.

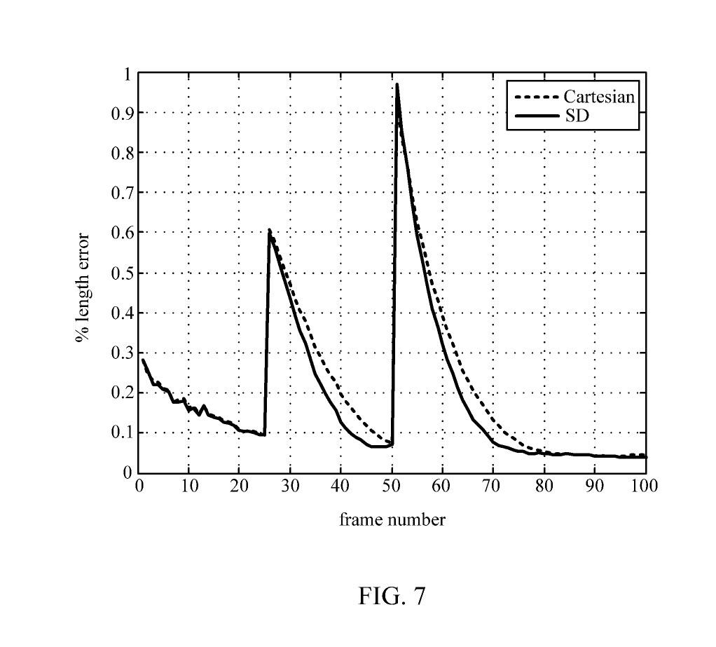

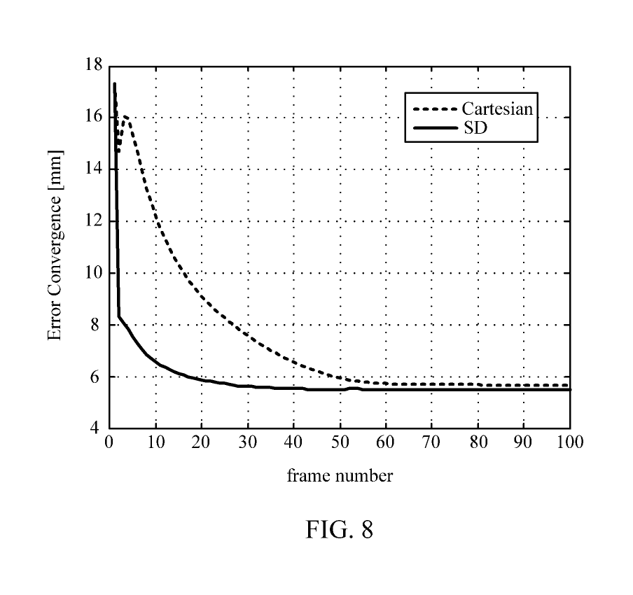

As shown in FIG. 7, the length error converges more quickly using the SD coordinate system. As shown in FIG. 8 the internal convergence of the error covariance occurs more quickly and the asymptotic error is lower.

### Clarifications Regarding Terminology

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A system for measuring a dimension of an object, comprising:
a pair of stereoscopic image sensors; and
a control module configured to:
capture a stereoscopic image of the object;
determine one or more keypoints of the object;
determine a boundary of the object from the one or more keypoints; and
calculate a dimension of the object based on a length of the determined boundary of the object; and
a display configured to display the object and the calculated dimension.

2. The system of claim 1, wherein the control module is further configured to track the keypoints in three dimensions.

3. The system of claim 2, wherein the control module is further configured to capture ten stereoscopic images of the object.

4. The system of claim 3, wherein the control module is further configured to determine a set of keypoint matches in common in a first image and a second image of each stereoscopic image.

5. The system of claim 1, wherein the control module is configured to determine one or more keypoints of the object by receiving input from a touchscreen of the system that identifies the object to be measured.

6. A method for measuring a dimension of an object, comprising:
capturing a stereoscopic image of the object;
determining one or more keypoints of the object;
determining a boundary of the object from the one or more keypoints; and
calculating a dimension of the object based on a length of the determined boundary of the object.

7. The method of claim 6 further comprising capturing at least 10 stereoscopic images of the object.

8. The method of claim 7, wherein determining one or more keypoints further comprises spatially correlating at least one common feature of a first image and a second image of each stereoscopic image of the object.

9. The method of claim 8, further comprising displaying an image of the object on a touch-sensitive device and selecting a dimension of an object to be measured by touching the boundary of the image of the object.

10. The method of claim 7 further comprising determining a set of keypoint matches in common in a first image and a second image of each stereoscopic image.

11. The method of claim 10 further comprising tracking the set of keypoints in three dimensions.

12. An imaging apparatus, comprising:
a pair of stereoscopic image sensors;
a sensor control module configured to capture a stereoscopic image of an object;
a keypoint module configured to determine one or more keypoints of the object;
a boundary calculation module configured to determine a boundary of the object from the one or more keypoints;
a user interface module configured to accept a user-selected boundary of the object;
a dimension calculation module configured to calculate a dimension of the object based on a length of the determined boundary of the object; and
a display configured to display the object and the calculated dimension.

13. The imaging apparatus of claim 12 further comprising a tracking module configured to track the one or more keypoints of the object in three dimensions.

14. The imaging apparatus of claim 13, wherein the tracking module is further configured to use disparity between keypoint measurements and keypoint position measurements as input to a tracking filter.

15. The imaging apparatus of claim 13, wherein the imaging apparatus is a wireless telephone.

16. A stereoscopic imaging device, comprising:
a pair of stereoscopic image sensors;
means for determining one or more keypoints of an object;
means for determining a boundary of the object from the one or more keypoints;
means for calculating a dimension of the object based on a length of the determined boundary of the object; and
a display configured to display the object and the calculated dimension.

17. The stereoscopic imaging device of claim 16 further comprising means for tracking the one or more keypoints of an object in three dimensions.

18. The stereoscopic imaging device of claim 17, wherein the means for tracking the one or more keypoints includes a tracking filter.

19. The stereoscopic imaging device of claim 17, wherein the means for determining one or more keypoints comprises a touchscreen configured to receive input identifying the object.

20. A non-transitory computer readable medium, storing instructions that when executed by a processor, cause the processor to perform the method of:
capturing a stereoscopic image of an object;
determining one or more keypoints of the object;
determining a boundary of the object from the one or more keypoints;
calculating a dimension of the object based on a length of the determined boundary of the object; and
tracking the one or more keypoints of the object in three dimensions.
